(19) United States
(12) Patent Application Publication
(10) Pub. No.: US 2024/0311713 A1
(43) Pub. Date: Sep. 19, 2024

(54) SYSTEMS AND METHODS FOR USING REAL TIME INTERACTIVE DATA WITH ARTIFICIAL INTELLIGENCE CAPABILITIES TO IMPROVE PRESENTATIONS

(71) Applicant: JPMORGAN CHASE BANK, N.A., New York, NY (US)

(72) Inventors: Jorje GONZALEZ, New York, NY (US); AnnMarie MAIER, Clearwater, FL (US); Ana BRAGG, Tampa, FL (US); Kristina HOLLOMAN, Spring Hill, FL (US)

(21) Appl. No.: 18/184,400

(22) Filed: Mar. 15, 2023

(51) Int. Cl. G06Q 10/0631

(52) U.S. Cl. CPC G06Q 10/063114

(57) ABSTRACT

Systems and methods for using real time interactive data with artificial intelligence capabilities to improve presentations are disclosed. In one embodiment, a method for using real time interactive data with artificial intelligence capabilities to improve presentations may include: (1) receiving, at a moderator computer program, a presentation for a presenter to present to an audience comprising a plurality of attendees; (2) monitoring, by the moderator computer program, the plurality of attendees to determine a sentiment or engagement level for the audience; (3) generating, by the moderator computer program, insights for the presenter based on the sentiment or engagement level; (4) providing, by the moderator computer program, the insights to an electronic device associated with the presenter; and (5) providing, by the moderator computer program, a summary of the presentation to the presenter and/or the plurality of attendees.

### BACKGROUND OF THE INVENTION

### 1. Field of the Invention

Embodiments relate generally to systems and methods for using real time interactive data with artificial intelligence capabilities to improve presentations.

### 2. Description of the Related Art

When a presenter gives a presentation to an audience, such as an on-line audience, it is difficult for the presenter to understand how the presentation is being received. For example, without attendees being physically present, a presenter may not be able to perceive whether he or she is speaking too quickly or too slowly, or how the presentation is being received. For example, do the attendees understand the presentation? Are attendees confused or bored? And, from the attendees' perspective, members may not want to ask a question because they are too shy or do not want to interrupt.

### SUMMARY OF THE INVENTION

Systems and methods for using real time interactive data with artificial intelligence capabilities to improve presentations are disclosed. In one embodiment, a method for using real time interactive data with artificial intelligence capabilities to improve presentations may include: (1) receiving, at a moderator computer program, a presentation for a presenter to present to an audience comprising a plurality of attendees; (2) monitoring, by the moderator computer program, the plurality of attendees to determine a sentiment or engagement level for the audience; (3) generating, by the moderator computer program, insights for the presenter based on the sentiment or engagement level; (4) providing, by the moderator computer program, the insights to an electronic device associated with the presenter; and (5) providing, by the moderator computer program, a summary of the presentation to the presenter and/or the plurality of attendees.

In one embodiment, the presentation may be a slide-based presentation.

In one embodiment, the method may also include identifying, by the moderator computer program and by using a trained machine learning or artificial intelligence engine, a plurality of potential audience questions based on the presentation; identifying, by the moderator computer program, answers to the plurality of potential questions; and making, by the moderator computer program, the answers available to the audience during the presentation.

In one embodiment, the moderator computer program may monitor facial expressions for one or more of the plurality of attendees, and determines the sentiment or engagement level using the facial expressions.

In one embodiment, the moderator computer program may monitor audio feedback from one or more of the plurality of attendees, and determines the sentiment or engagement level using the audio feedback.

In one embodiment, the moderator computer program may monitor questions from one or more of the plurality of attendees, and determines the sentiment or engagement level using the questions.

In one embodiment, the insights may include adjusting a rate at which the presentation is given, adjusting a level of detail of the presentation, etc.

According to another embodiment, a system may include: a presenter electronic device with a presenter executing a presenter computer application; an attendee image capture device; and a moderator electronic device executing a moderator computer program. The moderator computer program may receive a presentation for a presenter to present to an audience comprising a plurality of attendees. The attendee image capture device may capture images of a plurality of attendees. The moderator computer program may determine a sentiment or engagement level for the plurality of attendees based from the images, may generate insights for the presenter based on the sentiment or engagement level, may provide the insights to the presenter computer program, and may provide a summary of the presentation to the presenter and/or the plurality of attendees.

In one embodiment, the presentation may be a slide-based presentation.

In one embodiment, the moderator computer program may identify, using a trained machine learning or artificial intelligence engine, a plurality of potential audience questions based on the presentation, may identify answers to the plurality of potential questions, and may make the answers available to the audience during the presentation.

In one embodiment, the images may include facial expressions for one or more of the plurality of attendees, and the moderator computer program may determine the sentiment or engagement level using the facial expressions.

In one embodiment, the system may also include an audio capture device, and the moderator computer program may receive audio feedback from one or more of the plurality of attendees, and may determine the sentiment or engagement level using the audio feedback.

In one embodiment, the moderator computer program may monitor questions from one or more of the plurality of attendees, and may determine the sentiment or engagement level using the questions.

In one embodiment, the insights may include adjusting a rate at which the presentation is given, adjusting a level of detail of the presentation, etc.

According to another embodiment, a non-transitory computer readable storage medium, may include instructions stored thereon, which when read and executed by one or more computer processors, cause the one or more computer processors to perform steps comprising: receiving a presentation for a presenter to present to an audience comprising a plurality of attendees; monitoring the plurality of attendees to determine a sentiment or engagement level for the audience; generating insights for the presenter based on the sentiment or engagement level; providing the insights to an electronic device associated with the presenter; and providing a summary of the presentation to the presenter and/or the plurality of attendees.

In one embodiment, the non-transitory computer readable storage medium may also include instructions stored thereon, which when read and executed by one or more computer processors, cause the one or more computer processors to perform steps comprising: monitoring facial expressions for one or more of the plurality of attendees; and determining the sentiment or engagement level using the facial expressions.

In one embodiment, the non-transitory computer readable storage medium may also include instructions stored thereon, which when read and executed by one or more computer processors, cause the one or more computer processors to perform steps comprising: monitoring audio feedback from one or more of the plurality of attendees; and determining the sentiment or engagement level using the audio feedback.

In one embodiment, the insights may include adjusting a rate at which the presentation is given, adjusting a level of detail of the presentation, etc.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for using real time interactive data with artificial intelligence capabilities to improve presentations according to an embodiment;

FIG. 2 depicts a method for using real time interactive data with artificial intelligence capabilities to improve presentations according to an embodiment;

FIG. 3 depicts an exemplary computing system for implementing aspects of the present disclosure.

### DETAILED DESCRIPTION OF PREFERRED EMBODIMENTS

Embodiments are generally directed to systems and methods for using real time interactive data with artificial intelligence capabilities to improve presentations.

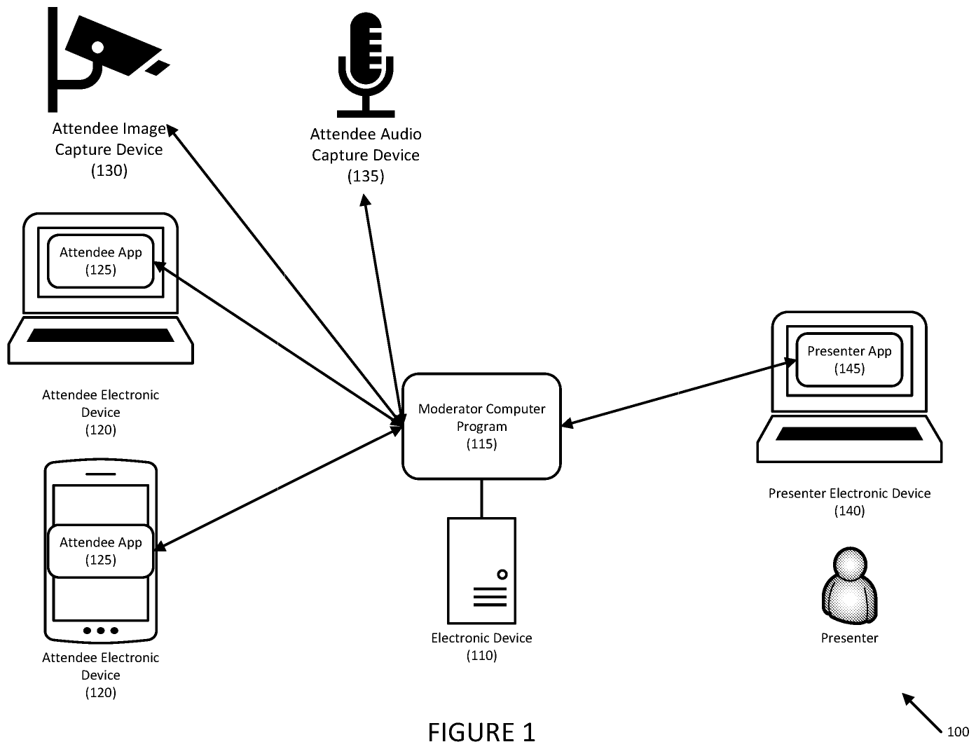

Referring to FIG. 1, a system for using real time interactive data with artificial intelligence capabilities to improve presentations is disclosed according to an embodiment. System 100 may include electronic device 110, which may be a server (e.g., cloud-based and/or physical), computers (e.g., workstations, desktops, laptops, notebooks, etc.), etc. Electronic device 110 may execute a computer program, such as moderator computer program 115, which may monitor a presentation given by a presenter.

Moderator computer program 115 may communicate with one or more attendee applications (“app”) 125 that may be executed by attendee electronic devices 120. Examples of attendee electronic devices may include computers (e.g., workstations, desktops, laptops, notebooks, etc.), smart devices (e.g., smart phones, smart watches, smart televisions, etc.), Internet of Things (IoT) devices, videoconference equipment, etc. Moderator computer program 115 may also receive streaming video data from one or more attendee image capture devices 130 and streaming audio data from attendee audio capture devices 135. Attendee image capture devices 130 may be cameras, such as web cameras, cameras that are integrated into attendee electronic devices 120, etc., and attendee audio capture devices 135 may be microphones, such as audioconferencing equipment, microphones integrated into attendee electronic devices 120, etc.

In one embodiment, attendees may attend the presentation in-person, using a mobile device, in the metaverse, by calling in, by web presence, etc.

In one embodiment, moderator computer program 115 may use facial recognition software and/or a trained machine learning engine to identify a sentiment or engagement level of the attendees based on the image data. Similarly, moderator computer program 115 may use a trained machine learning engine to determine a sentiment or engagement level of the attendees based on audio data.

In one embodiment, prior to making a presentation, a presenter may upload a copy of a presentation, such as slides, notes to accompany the slides, etc. to moderator computer program 115. Moderator computer program 115 may apply artificial intelligence and/or machine learning to identify potential questions that may be asked by the attendees. Moderator computer program 115 may also identify answers to the questions from, for example, the presentation, searches, etc. If the answer cannot be determined, moderator computer program 115 may request an answer from the presenter.

In one embodiment, moderator computer program 115 may use a neural network to identify questions and possible answers based on the presentation. For example, moderator computer program may use rules that may be used to identify similarities with previous data submitted from recorded meetings and look for key words to identify similar words and phrases to group into 1 new question. For questions submitted orally, embodiments may transcribe the questions for moderator computer program 115 to analyze before providing a response. This will help the neural network learn frequently asked questions and have the best response available for implementation.

Moderator computer program 115 may make the questions and answers available to the attendees during the presentation via, for example, attendee apps 125.

The presenter may present a presentation live, on-line, or a combination of both, using any suitable presentation mechanism. In one embodiment, moderator computer program 115 may monitor the presentation and may capture, for example, audio and video of the presenter, the progress of the presentation, etc. Moderator computer program 115 may use the observations on the presenter, the presentation, and/or received attendee information to provide feedback to the presenter on presenter application 145 that is executed by presenter electronic device 140. For example, using machine learning and/or artificial intelligence, moderator computer program 115 may provide the presenter with visual data of the attendees, questions pending, transmission errors, etc., and may provide a suggestion of presenting at a certain level (e.g., novice, advanced beginner, or expert level) based on the information collected.

Moderator computer program 115 may also present attendees with polls, surveys, etc. on attendee apps 125. For example, a presenter may pre-populate certain items as part of the presentation to be presented as specified points in the presentation, and to record the responses.

Attendees may submit, anonymously if desired, questions to the presenter using attendee app 125. Attendees may communicate questions in various forms, including audio, digital, sign language, etc. and the questions may be received by moderator computer program 115. Moderator computer program 115 may identify the questions and may determine if the question is one of the identified questions; if it is, moderator computer program 115 may provide the answer to the attendee. If not, moderator computer program 115 may bundle the question with similar questions and provide it to presenter application 145.

In one embodiment, questions may be received prior to the presentation, and may capture facial emotion, and audio of those speaking. Embodiments may allow attendees to vote on questions that are submitted in real time.

At the end of the presentation, a presentation summary may be generated automatically based on information collected. For example, a report showing, for example, interest/disinterest, participation, those who submit and those who provide only non-verbal questions, may be provided to the presenter.

Embodiments may also integrate with artificial intelligence systems, such as Chat GPT. For example, to respond to off-topic questions (i.e., questions that are not covered by the materials), embodiments may use an artificial intelligence system to scrape the Internet for a response.

In embodiments may pre-record responses to certain questions, such as FAQs, for deaf/hard of hearing users. In addition, embodiments may use a text-to-speech translator that allows users to enter text and have the text converted to speech. This may be helpful when asking a question.

In another embodiment, embodiments may provide visually impaired individuals with pre-recorded answers to certain questions (e.g., FAQs).

Embodiments may accept emoji language as feedback and track w when it is used throughout the presentation.

Embodiments may provide reporting upon completing a presentation of registered user interaction.

Embodiments may share a recording of the presentation with the registered user.

Embodiments may track user the user engagement time and may track the face of the individuals for engagement within the presentation.

Embodiments may identify the most interactive points of a presentation and create a marketing clip.

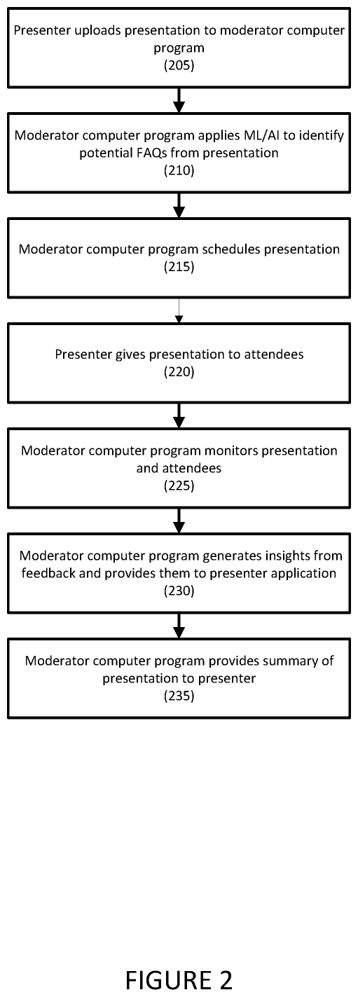

Referring to FIG. 2, a method for using real time interactive data with artificial intelligence capabilities to improve presentations is disclosed according to an embodiment.

In step 205, a presenter may upload a presentation to a moderator computer program. The presentation may include slides, notes, etc. In one embodiment, the presenter may identify one or more channel for the presentation, and may identify locations for the presentation to be viewed.

In step 210, the moderator computer program may apply ML/AI to the presentation to identify potential attendee questions. The moderator computer program may also determine answers from the questions from the presentation or from on-line research, or may ask the presenter to answer the question.

For example, the moderator computer program may use ML/AI to identify questions in public presentations online and offer the presenter to add those questions to the questions. The presenter may opt to include subject matter expert acronyms/jargon value and the ML/AI may auto populate the question with the entered value. It will also reference previous questions asked from prior presentations as optional questions to add to improve the presentation. If the participants vote the same question is still needing to be answered, this is a metric identifier the presentation needs further modifications.

In step 215, the moderator computer program may schedule the presentation and may reserve any resources needed (e.g., conference rooms, audio/visual equipment, etc.). In one embodiment, the moderator computer program may set up a video conference channel, a metaverse location, a dial-in number, etc. and may communicate the information to the attendees.

In one embodiment, the moderator computer program may provide a link for the attendees to download attendee application on attendee electronic devices.

In step 220, the presenter may give the presentation to the attendees. For example, the presenter may give the presentation over one or more channels.

In step 225, the moderator computer program may monitor presentation and attendees. In one embodiment, the moderator computer program may receive facial data and/or audio data from the attendees and may assess a sentiment or engagement level of the attendees. For example, the moderator computer program may use facial recognition software and/or a trained machine learning engine to identify a sentiment or engagement level of the attendees based on the image data. Similarly, the moderator computer program may use a trained machine learning engine to determine a sentiment or engagement level of the attendees based on audio data.

The moderator computer program may also receive questions from the attendees. For example, using the attendee app, attendees may submit, anonymously if desired, questions to the presenter. Attendees may communicate questions in various forms, including audio, digital, sign language, etc. and the questions may be received by the moderator computer program. The moderator computer program may identify the questions and may determine if the question is one of the identified questions; if it is, the moderator computer program may provide the answer to the attendee. If not, the moderator computer program may bundle the question with similar questions and provide it to the presenter application.

In step 230, the moderator computer program may generate insights from the feedback and monitoring of the presentation and may provide them to the presenter application. For example, using machine learning and/or artificial intelligence, the moderator computer program may provide the presenter with visual data of the attendees, questions pending, transmission errors, etc., and may provide a suggestion of presenting at a certain level (e.g., novice, advanced beginner, or expert level) based on the information collected. It may further make recommendations on the speed of the presentation (e.g., speed up, slow down), etc. to meet timing goals, whether something should be repeated because the attendees look confused, whether to expedite a portion because the attendees look bored, etc.

In step 235, the moderator computer program may provide a summary of presentation to the presenter. For example, a report showing, for example, interest/disinterest, participation, those who submit and those who provide only non-verbal questions, may be provided to the presenter.

In one embodiment, questions that are unanswered may be summarized and left for the moderator to address at the end of the presentation. The moderator and registered users may have the ability to engage with various points of data that would be helpful to them to understand their audience and moderator. For example, the suggestions from the system to the moderator may be short and easy to understand such as the phrase, repeat the last point, slow down, speed up to improve the presentation in real time.

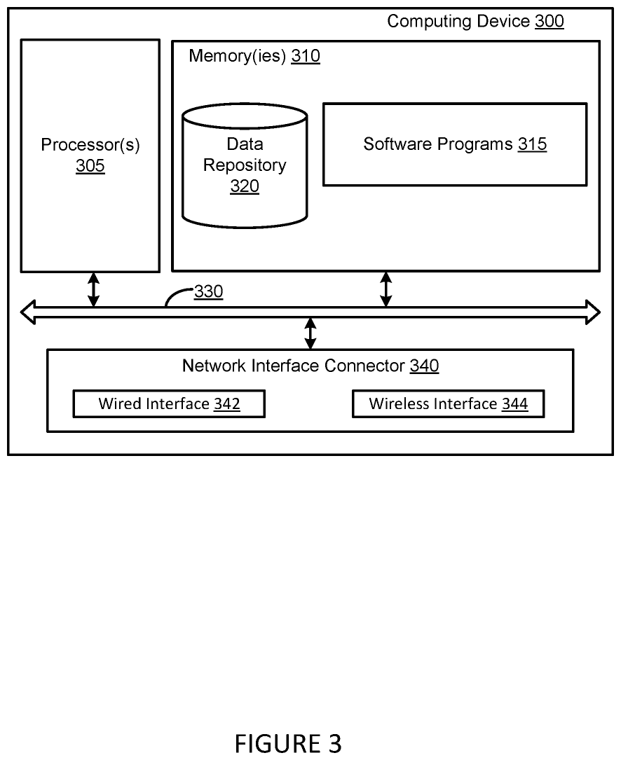

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized

processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for using real time interactive data with artificial intelligence capabilities to improve presentations comprising:
receiving, at a moderator computer program, a presentation for a presenter to present to an audience comprising a plurality of attendees;
monitoring, by the moderator computer program, the plurality of attendees to determine a sentiment or engagement level for the audience;
generating, by the moderator computer program, insights for the presenter based on the sentiment or engagement level;
providing, by the moderator computer program, the insights to an electronic device associated with the presenter; and
providing, by the moderator computer program, a summary of the presentation to the presenter and/or the plurality of attendees.

2. The method of claim 1, wherein the presentation is a slide-based presentation.

3. The method of claim 1, further comprising:
identifying, by the moderator computer program and by using a trained machine learning or artificial intelligence engine, a plurality of potential audience questions based on the presentation;
identifying, by the moderator computer program, answers to the plurality of potential questions; and
making, by the moderator computer program, the answers available to the audience during the presentation.

4. The method of claim 1, wherein the moderator computer program monitors facial expressions for one or more of the plurality of attendees, and determines the sentiment or engagement level using the facial expressions.

5. The method of claim 1, wherein the moderator computer program monitors audio feedback from one or more of the plurality of attendees, and determines the sentiment or engagement level using the audio feedback.

6. The method of claim 1, wherein the moderator computer program monitors questions from one or more of the plurality of attendees, and determines the sentiment or engagement level using the questions.

7. The method of claim 1, wherein the insights comprises adjusting a rate at which the presentation is given.

8. The method of claim 1, wherein the insights comprises adjusting a level of detail of the presentation.

9. A system, comprising:
a presenter electronic device with a presenter executing a presenter computer application;
an attendee image capture device; and
a moderator electronic device executing a moderator computer program;
wherein:
the moderator computer program receives a presentation for a presenter to present to an audience comprising a plurality of attendees;
the attendee image capture device captures images of a plurality of attendees;
the moderator computer program determines a sentiment or engagement level for the plurality of attendees based from the images;
the moderator computer program generates insights for the presenter based on the sentiment or engagement level;
the moderator computer program provides the insights to the presenter computer program; and
the moderator computer program provides a summary of the presentation to the presenter and/or the plurality of attendees.

10. The system of claim 9, wherein the presentation is a slide-based presentation.

11. The system of claim 9, wherein the moderator computer program identifies, using a trained machine learning or artificial intelligence engine, a plurality of potential audience questions based on the presentation, identifies answers to the plurality of potential questions, and make the answers available to the audience during the presentation.

12. The system of claim 9, wherein the images comprise facial expressions for one or more of the plurality of attendees, and the moderator computer program determines the sentiment or engagement level using the facial expressions.

13. The system of claim 9, further comprising an audio capture device, and wherein the moderator computer program receives audio feedback from one or more of the plurality of attendees, and determines the sentiment or engagement level using the audio feedback.

14. The system of claim 9, wherein the moderator computer program monitors questions from one or more of the plurality of attendees, and determines the sentiment or engagement level using the questions.

15. The system of claim 9, wherein the insights comprises adjusting a rate at which the presentation is given.

16. The system of claim 9, wherein the insights comprises adjusting a level of detail of the presentation.

17. A non-transitory computer readable storage medium, including instructions stored thereon, which when read and executed by one or more computer processors, cause the one or more computer processors to perform steps comprising:
receiving a presentation for a presenter to present to an audience comprising a plurality of attendees;
monitoring the plurality of attendees to determine a sentiment or engagement level for the audience;
generating insights for the presenter based on the sentiment or engagement level;
providing the insights to an electronic device associated with the presenter; and
providing a summary of the presentation to the presenter and/or the plurality of attendees.

18. The non-transitory computer readable storage medium of claim 17, further including instructions stored thereon, which when read and executed by one or more computer processors, cause the one or more computer processors to perform steps comprising:
monitoring facial expressions for one or more of the plurality of attendees; and
determining the sentiment or engagement level using the facial expressions.

19. The non-transitory computer readable storage medium of claim 17, further including instructions stored thereon, which when read and executed by one or more computer processors, cause the one or more computer processors to perform steps comprising:
monitoring audio feedback from one or more of the plurality of attendees; and
determining the sentiment or engagement level using the audio feedback.

20. The non-transitory computer readable storage medium of claim 17, wherein the insights comprises adjusting a rate at which the presentation is given or adjusting a level of detail of the presentation.
